(19) United States
(12) Patent Application Publication
(10) Pub. No.: US 2026/0092838 A1
(43) Pub. Date: Apr. 2, 2026

(54) LOCK FOR INTRODUCING AND DISCHARGING A SAMPLE RECEIVING ELEMENT INTO A MASS SPECTROMETER

(71) Applicant: Bruker Daltonics GmbH & Co. KG, Bremen (DE)

(72) Inventors: Andreas HOEHNE, Bremen (DE); Ole LUNITZ, Bremen (DE)

(21) Appl. No.: 19/344,867

(22) Filed: Sep. 30, 2025

(30) Foreign Application Priority Data
Sep. 30, 2024 (DE) 102024128215.0
Sep. 30, 2024 (DE) 102024128219.3

(51) Int. Cl. G01N 1/02; G01N 1/00; H01J 49/04

(52) U.S. Cl. CPC G01N 1/02; H01J 49/0418; H01J 49/0495; G01N 2001/002; H01J 2237/2007; H01J 2237/20221; H01J 2237/20264

(57) ABSTRACT

A lock for introducing and discharging a sample receiving element into a mass spectrometer is described. Also described is a set comprising a holder for sample receiving elements and a sample receiving element that can be held by the holder. Also described is a mass spectrometer, in particular a MALDI-TOF mass spectrometer.

### BACKGROUND OF THE INVENTION

### Field of the Invention

The present invention relates to a lock for introducing and discharging a sample receiving element into a mass spectrometer. The present invention further relates to a set comprising a holder for sample receiving elements and a sample receiving element that can be held by the holder. The present invention also relates to a mass spectrometer, in particular a MALDI-TOF mass spectrometer.

### Description of the Related Art

The invention is defined in the appended patent claims. Furthermore, preferred aspects of the present invention are apparent from the following description, including the examples.

Insofar as certain embodiments are designated as preferred for an aspect according to the invention, the corresponding explanations also apply in each case to the other aspects of the present invention, mutatis mutandis. Preferred individual features of aspects according to the invention (as defined in the claims and/or disclosed in the description) can be combined with each other and are preferably combined with each other, unless otherwise apparent to the skilled person from the present text in individual cases.

The use of mass spectrometers has long been established for the analysis of biomolecules, among other things. The introduction of matrix-assisted laser desorption/ionization (MALDI) and electrospray ionization (ESI) as extremely gentle ionization methods has significantly advanced the possibility of investigating biological molecules in this context.

The ionization of analyte molecules using MALDI is of great importance in mass spectrometry imaging of thin tissue sections (MSI), for example, and it is predominantly used as the preferred ionization method (see, for example, Dreisewerd, K., Bien, T., Soltwisch, J. (2022) “MALDI-2 and t-MALDI-2 Mass Spectrometry Imaging” in: Lee, Y J. (eds) “Mass Spectrometry Imaging of Small Molecules. Methods in Molecular Biology,” vol. 2437, Humana, New York, NY. https://doi.org/10.1007/978-1-0716-2030-4_2). A typical analysis involves scanning the surface of a matrix-coated sample (usually a tissue section) with a focused laser beam and recording a complete mass spectrum at each position. Special software tools then reconstruct the data obtained in this way into a molecular image by mapping the intensity of each mass signal to the position in the tissue section where it was recorded.

The resolution achievable in mass spectrometry imaging depends, among other things, on the precision with which the sample to be examined can be moved during a measurement for the purpose of successive scanning with the focused laser beam or continuously positioned under the laser beam (see, for example, John C. Jurchen, Stanislav S. Rubakhin, Jonathan V. Sweedler, “MALDI-MS Imaging of Features Smaller than the Size of the Laser Beam,” J. Am. Soc. Mass Spectrom., 2005, 16, 1654-1659). The sample is moved as standard via a positioning table (also referred to as a motion mechanism in the context of the invention), on or to which a sample carrier or, alternatively, a sample receiving element serving to insert the sample carrier into the mass spectrometer can be attached. Piezo stages are particularly suitable for precise movement of the sample during a measurement, as they enable finely graded and highly precise movement, even in the nanometer range (see, for example, M. Niehaus, J. Soltwisch, M. E. Belov, K. Dreisewerd, “Transmission-mode MALDI-2 mass spectrometry imaging of cells and tissues at subcellular resolution,” Nature Methods, 2019, 16, 925-931).

The positioning table for moving the sample is located in the area of the mass spectrometer where the sample to be examined is ionized (i.e., in the ion source). During operation of the mass spectrometer, this area is usually under negative pressure, which must be restored when the mass spectrometer is opened to insert a sample to be examined before the actual analysis of the sample. In order to maintain the negative pressure in the mass spectrometer during a sample change, it is generally possible to transport the sample via an evacuable lock. In conventional mass spectrometers that are suitable for mass spectrometry imaging and have a lock, the positioning table usually covers most of the transport distance that the sample receiving element has to travel from an operator interface (i.e., an area outside the mass spectrometer) through the lock to the positioning table. For this purpose, the positioning table can move into the lock and receive the sample receiving element already in the lock. However, not all types of positioning tables are suitable for such a transport function. For example, high-precision piezo stages are not suitable for such an additional function due to their comparatively weak piezo motors.

### SUMMARY OF THE INVENTION

In order to be able to use high-precision motion mechanisms, such as piezo stages, for moving a sample during measurement and at the same time to enable the introduction of the samples to be examined via a lock, the primary problem to be solved by the present invention was to provide a lock for introducing and discharging a sample (more precisely, for introducing and discharging a sample receiving element comprising a sample carrier holding a sample) into a mass spectrometer, which does not necessarily rely on support from the motion mechanism used to move the sample during an imaging mass spectrometric measurement in order to transport the sample (the sample receiving element) through the lock. Another problem to be solved by the present invention was to provide a mass spectrometer that can achieve high-precision movement of a sample during an imaging mass spectrometric measurement and at the same time enables quick and easy insertion and removal of samples (more precisely, sample receiving elements comprising sample carriers holding a sample).

Further problems to be solved result from the following description and the claims.

The primary problem underlying the present invention is solved by a preferably evacuable lock for introducing and discharging a sample receiving element (having a groove for receiving a pin) into a mass spectrometer, preferably a MALDI-TOF mass spectrometer, comprising
a first opening for introducing the sample receiving element from an external area into the lock,
a second opening for introducing the sample receiving element from the lock into an internal area of the mass spectrometer, preferably into an internal area for ionizing a sample to be analyzed and/or into a low-pressure zone inside the mass spectrometer,
a first lock gate for closing the first opening of the lock, and
a second lock gate for closing the second opening of the lock,
wherein the lock additionally comprises a transport device arranged in the lock for transporting the sample receiving element from the first opening of the lock into the internal area of the mass spectrometer (and back), wherein the transport device comprises the following components:
   a rotatable element comprising
      an arm,
      a pin located on the arm, which can be inserted into a groove of the sample receiving element to be transported, and
      a gear-like section,
   a linear drive for moving the rotatable element from the first opening of the lock into the internal area of the mass spectrometer (and back), wherein the linear drive comprises a rack on at least one section and the rack is designed to engage with the teeth of the gear-like section of the rotatable element,
and wherein the rotatable element performs a rotational movement when passing over the rack, so that the pin located on the arm of the rotatable element can be guided into and along the groove located in the sample receiving element and, upon contact of the pin with the sample receiving element, a movement of the sample receiving element from the first opening of the lock into the internal area of the mass spectrometer (and back) can be achieved by movement of the pin.

Since, in accordance with the above-mentioned problem to be solved, the lock should enable to dispense with support for any motion mechanisms arranged in the internal area of the mass spectrometer (intended for moving a sample during a measurement process) during transport/introduction of a sample receiving element through the lock and into the internal area, one challenge was to accomplish the transport entirely by means of the transport device arranged in the lock. Particularly in the case of transporting sample receiving elements to or onto a sensitive motion mechanism located in the internal area of the mass spectrometer, a further challenge was to accomplish the transport to or onto the motion mechanism with as little force as possible in order to avoid any damage to the motion mechanism. These challenges were solved by the transport device arranged in the lock according to the invention.

The fact that the transport device is located in the lock and must simultaneously transport sample receiving elements into the internal area of the mass spectrometer is taken into account by the rotatable element comprised by the transport device, which functions as a kind of transmission or motion amplifier and enables the transport of sample receiving elements into the internal area of the mass spectrometer. A (without exception) arrangement of the transport device inside the lock is therefore advantageous, since typical high-precision motion mechanisms for moving samples during a measurement process, such as piezo stages, require a relatively large amount of space and therefore, particularly when a mass spectrometer is to be equipped with such a high-precision motion mechanism, the space in the internal area of the mass spectrometer, especially the space in the internal area for ionizing a sample to be analyzed, is very limited and, in case of doubt, does not allow the arrangement of an (additional) transport unit in the internal area of the mass spectrometer for the introduction and discharge of sample receiving elements.

Furthermore, the transport device arranged in the lock according to the invention enables relatively smooth movement of sample receiving elements through the lock and into the internal area of the mass spectrometer, and the guidance or deposition of a transported sample receiving element onto a motion mechanism located in the internal area of the mass spectrometer with comparatively little force being exerted on the motion mechanism.

The term “sample receiving element” as used in the context of the invention comprises elements onto which a sample to be analyzed can be applied directly, as well as elements in which one or more sample carriers (e.g., stainless steel plates or, preferably, glass slides coated with indium tin oxide (ITO)) can be held. Preferably, a “sample receiving element” within the meaning of the invention is a holder for sample carriers.

According to the invention, the first and second openings of the lock also serve to remove the sample receiving element, i.e., the first opening also serves to remove the sample receiving element from the lock to the external area, and the second opening also serves to remove the sample receiving element from the internal area of the mass spectrometer into the lock.

The rotatable element of the transport device can, according to the present invention, be made partially or completely of a single piece (i.e., monolithic) or from several pieces connected to each other. For example, the arm and the gear-like section of the rotatable element can be individual components distinguishable from each other, which are firmly connected to each other, for example, by a screw connection. Preferably, the arm and the gear-like section of the rotatable element are made of one piece.

In the context of the invention, a “gear-like section” refers to a round section with teeth evenly distributed around its exterior. Preferably, the gear-like section has a circular shape. Furthermore, the teeth evenly distributed around its exterior area preferably extend over an radian measure of at least π rad, so that the gear-like section enables at least a 180° rotational movement of the arm comprised by the rotatable element when completely traversing the rack of the linear drive.

The linear drive for moving the rotatable element can be designed in various ways and may, for example, comprise a threaded rod extending along the first and second openings of the lock with a motor movable on the threaded rod. In this case, the rotatable element is arranged on the linear drive in such a way that (i) the movement of the motor movable on the threaded rod also allows the rotatable element to be moved between the first and second openings of the lock, and (ii) the gear-like section of the rotatable element can simultaneously engage with the rack comprised by the linear drive on at least one section, thereby enabling the rotatable element to perform a rotational movement.

The groove located along the sample receiving element to be transported and the pin located on the arm of the rotatable element are matched in terms of size and shape so that the pin can be easily inserted into the groove and moved along the groove. At the same time, the pin should preferably not have too much play in the groove so that, after the pin has been inserted into the groove and as it continues to move, contact between the pin and the sample receiving element can be produced as quickly as possible and the sample receiving element can be moved by moving the pin. Preferably, the size and shape of the pin and groove are matched so that the pin can still move easily along the groove.

The insertion of the pin into the groove of the sample receiving element is achieved by a rotational movement of the rotatable element, which causes the pin located on the arm of the rotatable element to enter the groove of the sample receiving element. Continuing the rotational movement after the pin has been inserted into the groove of the sample receiving element causes the pin to move successively inside the groove and the pin (in contact with the sample receiving element) simultaneously exerts a force on the sample receiving element, which results in a movement of the sample receiving element. Since the pin can move freely along an axis inside the groove of the sample receiving element during its rotational movement, the sample receiving element itself does not undergo any rotational movement, but instead undergoes (at least largely) linear movement in the direction of one of the two openings of the lock.

In addition to the rotational movement, which is triggered by the meshing of the gear-like section of the rotatable element with the rack section comprised by the linear drive, the rotatable element—and thus also the pin on the arm of the rotatable element —can also undergo a linear movement in the direction of one of the two openings of the lock via the linear drive during active operation of the transport device. When the pin comes into contact with the groove of the sample receiving element, this movement is also transferred to the sample receiving element. Due to the fact that the sample receiving element receives a linear movement impulse in the direction of one of the two openings of the lock both through the rotational movement of the rotatable element (or the pin located on the arm of the rotatable element) and through the linear movement of the rotatable element, a longitudinal movement of the sample receiving element can be achieved which is greater than the distance between the two openings of the lock and is therefore not only suitable for transporting the sample receiving element from one opening of the lock to the other opening, but also, for example, enables the sample receiving element to be moved into the internal area of the mass spectrometer during the lock-in process.

The lock gates of the lock according to the invention serve to reversibly close the respective opening of the lock, for example to enable the lock to be flushed with an inert gas or, preferably, to generate a negative pressure in the lock. The first and second lock gates can be controlled independently of each other.

In order to maintain the pressure and atmosphere prevailing inside the mass spectrometer during operation, the second opening of the lock (leading into the internal area of the mass spectrometer) usually initially remains closed by the second lock gate during the process of introducing a sample receiving element into the internal area of the mass spectrometer. Instead, the first lock gate is opened first and a sample receiving element is inserted into the lock from an external area through the first opening that is thereby released. After the sample receiving element has been fully inserted, the first opening is closed by the first lock gate in a next step and the lock is preferably evacuated in a completely closed state before the second lock gate is opened and the sample receiving element can then be transported through the second opening into the internal area of the mass spectrometer.

Part of the invention is also a lock for introducing and discharging a sample receiving element into a mass spectrometer, preferably a MALDI-TOF mass spectrometer, comprising
a first opening for introducing the sample receiving element from an external area into the lock,
a second opening for introducing the sample receiving element from the lock into an internal area of the mass spectrometer, preferably into an internal area for ionizing a sample to be analyzed and/or into a low-pressure zone inside the mass spectrometer,
a first lock gate for closing the first opening of the lock, and
a second lock gate for closing the second opening of the lock,
wherein the first and/or the second lock gate
   is arranged inside the lock, and
   is designed and configured to first move parallel to that wall in which the opening to be closed is located and, after reaching the (full) level of the opening, to move toward the opening so that the opening is completely covered and closed by the lock gate.

In conventional devices, the lock gates of a lock are usually located on the outside of the lock, as the space available in a lock is limited as standard and is preferably kept as small as possible. A small volume inside the lock offers the advantage that the evacuation and/or flushing of the lock, which is usually necessary for the introduction of a sample, can be carried out more quickly and with less cost and energy expenditure.

However, the arrangement of the lock gates on the outer sides of the lock requires that there be sufficient space on their outer sides for the installation and opening of the lock gates. In particular, for the lock gate that is responsible for closing the opening to the internal area of the mass spectrometer, it may be the case that there is not enough space inside the mass spectrometer to install a lock gate there. This situation can occur in particular if, for example, high-precision motion mechanisms are desired in the internal area of the mass spectrometer for moving samples during a measurement process, since high-precision motion mechanisms—as mentioned above—usually require a large amount of space.

In cases where the conventional arrangement of one or more lock gates on the outside of the lock is not possible due to the existing conditions, the purpose is to find another suitable option for installing the lock gates. This purpose is solved by the above-mentioned part of the invention, in which the lock gates are arranged inside the lock. The aforementioned mechanism for closing the lock gates allows the lock gates to be opened and closed with very little space required, while at the same time ensuring a preferably sufficiently airtight closure of the openings, which, for example, allows the lock to be evacuated without any problems when closed. This makes it possible to arrange the lock gates inside the lock without requiring at least a noticeably larger dimensioning of the lock, even in those cases where the lock additionally comprises a transport device for transporting sample receiving elements inside the lock.

According to the part of the invention mentioned above, when closed, the lock gate presses against the lock from the inside and completely encloses the respective opening of the lock, so that the respective opening is preferably sealed airtight.

The aforementioned design and arrangement of the first and/or second lock gate also makes it possible to design them to be self-locking, which means that they can also be used to achieve and maintain higher negative pressures in the lock. Therefore, a lock according to the invention is preferred, wherein the first and/or second lock gate is mechanically self-locking.

As already mentioned above, when introducing samples or sample receiving elements, after the sample has been placed in the lock and before it is transported further into the internal area of the mass spectrometer, the lock is usually first evacuated and/or flushed with inert gas. In this context, a lock according to the invention is preferred, wherein
the first opening of the lock can be closed airtight by the first lock gate and/or
the second opening of the lock can be closed airtight by the second lock gate and/or
a negative pressure can be generated in the lock when the first and second openings are closed (i.e., the lock can be evacuated).

As already explained above, the linear drive for moving the rotatable element can be designed in various ways.

A lock according to the invention is preferred, wherein the linear drive comprises a threaded rod, wherein the threaded rod preferably extends over the entire length of the linear drive.

Preferably, the linear drive additionally has an element that can be moved along the threaded rod, such as a worm gear motor, to which the rotatable element is attached and via which the rotatable element is moved along the threaded rod.

Extending the threaded rod preferably over the entire length of the linear drive or over the entire distance between the first and second openings of the lock has the advantage that this creates the greatest possible movement length of the rotatable element between the two openings of the lock by utilizing the threaded rod.

A lock according to the invention is also preferred, wherein the linear drive has a section comprising a rack at at least one of its two ends, wherein the linear drive preferably comprises a rack at least at its end facing the first opening, wherein the linear drive more preferably comprises a rack exclusively at its end facing the first opening. This ensures that a rotational movement of the pin located on the arm of the rotatable element is already realized at at least one end of the linear drive, whereby the pin is either inserted into or removed from a groove of the sample receiving element, and thus ‘gripping’ or “releasing” of the sample receiving element already takes place when the rotatable element moves at at least one of the two outermost ends of the linear drive. This allows the entire distance traveled by the rotatable element via the linear drive to be used for transporting the sample receiving element.

Rotational movements of the rotatable element can be caused by the presence of several sections comprising a rack on the path that can be covered by the rotatable element through the linear drive. It is conceivable, for example, that a first section comprising a rack is initially located at the end of the linear drive facing the first opening, through which a first rotational movement (for example, a 90° rotation) is performed to insert the pin into the groove of the sample receiving element, the sample receiving element is then transported to the other end of the linear drive by means of a translational movement of the linear drive, and a further section comprising a rack is located there, by means of which a further rotational movement of the pin is performed for further/additional movement of the sample receiving element and for the pin to be removed again from the groove of the sample receiving element, and thus to decoupling the sample receiving element from the transport device.

Preferably, the linear drive comprises a rack on only a single continuous section. Among other things, this reduces the number of individual components for the transport device and thus its complexity, which, for example, enables faster and easier manufacturing of the lock and its transport device.

A lock according to the invention is preferred, wherein all sections of the linear drive which comprise a rack together cause a rotational movement of the rotatable element by 180°. The realization of a rotational movement for the rotatable element (as well as for its arm and the pin located thereon) by 180° has the advantage that this allows a considerable movement of the sample receiving element through the lock to be achieved and, during a rotation of 180°, the pin has the possibility of moving completely through the groove of the sample receiving element and back again within the scope of the rotational movement, so that the pin—depending on its initial position relative to the groove and the shape of the arm—is either outside the groove again or close to the opening for inserting the pin into the groove after completing a 180° rotation, which facilitates a renewed decoupling of the groove and the pin after the sample receiving element has been transported.

A lock according to the invention is preferred, wherein the arm of the rotatable element (or at least the main section of the arm of the rotatable element) is aligned horizontally when the rotatable element stops at the end of the linear drive facing the first opening, wherein, preferably, the arm of the rotatable element (or at least the main section of the arm of the rotatable element) is aligned horizontally when the rotatable element stops at any one of the two ends of the linear drive.

A “stop” of the rotatable element at one of the two ends of the linear drive means that the rotatable element is in the start or end position for transporting the sample receiving element and that no further movement of the rotatable element beyond this end should or can take place.

Horizontal alignment of the arm of the rotatable element (or at least of its main section) when the rotatable element stops at the end of the linear drive facing the first opening has the advantage, for example, that a sample receiving element to be inserted into the lock can be easily pushed over the arm into the lock without the arm getting in the way of the sample receiving element being inserted into the lock. Ideally, the sample receiving element is inserted into the lock in such a way that the opening of the groove of the sample receiving element and the pin located on the arm of the rotatable element are opposite each other and the pin can be inserted into the groove of the sample receiving element as part of a rotational movement preferably already taking place at the beginning of the transport process through the lock.

Horizontal alignment of the arm of the rotatable element (or at least of its main section) when the rotatable element stops at the end of the linear drive facing the second opening has the additional advantage that this either automatically decouples the pin of the arm of the rotatable element and the groove of the sample receiving element after the sample receiving element has been transported into the internal area of the mass spectrometer, or at least simplifies this process.

The “main section” of the arm of the rotatable element refers to the longest section of the arm that forms a straight line. This term takes into account the fact that the arm of the rotatable element does not necessarily have to be completely straight, but may alternatively have one or more bends.

A lock according to the invention is preferred, wherein the arm of the rotatable element has a bend at its end (facing away from the center of the rotatable element), wherein the bend of the arm preferably points downward or away from a sample receiving element inserted into the first opening of the lock when the rotatable element stops at the end of the linear drive facing the first opening of the lock.

A corresponding bend in the arm of the rotatable element can help to ensure that the arm does not block the insertion of a sample receiving element. A bend in the arm, which points downward when the rotatable element stops at the end of the linear drive facing the first opening of the lock, can further ensure that the pin inserted into the groove of the sample receiving element by a rotational movement remains in the groove even after a preferred rotational movement of 180°, so that contact between the sample receiving element and the transport device remains even after a rotational movement of 180°, and the sample receiving element can thus continue to be moved via the linear drive of the transport device even after completion of such a rotational movement.

In those cases where, after the transport device has completed the entire transport path for introducing a sample receiving element, there is still contact between the groove of the sample receiving element and the pin of the arm of the rotatable element, this contact is preferably separated with the aid of a motion mechanism located in the internal area of the mass spectrometer. For this purpose, the transport of the sample receiving element into the interior of the mass spectrometer can be designed in such a way that the sample receiving element to be introduced is fixed in or on a motion mechanism located in the internal area of the mass spectrometer as part of the introduction process, and that subsequent movement of the motion mechanism enables the contact between the groove of the sample receiving element and the pin of the arm of the rotatable element to be released. Preferably, only a slight movement of the motion mechanism without the application of particularly high force is required to release the contact between the groove of the sample receiving element and the pin of the arm of the rotatable element, so that such a movement can also be easily achieved by high-precision motion mechanisms with comparatively little range of motion.

A lock according to the invention is preferred, wherein the lock additionally comprises an obstacle against which a sample receiving element abuts when inserted into the first opening and by which the length to which a sample receiving element can be inserted through the first opening into the lock is limited and/or
the shape of the sample receiving element is matched to the shape of the first opening of the lock in such a way that the sample receiving element can only be inserted into the first opening in one orientation and/or
the arrangement and design of the first opening of the lock, the transport device of the lock and the sample receiving element that can be inserted into the first opening of the lock are matched to each other in such a way that after the sample receiving element has been inserted into the first opening (i.e., after the sample receiving element has been inserted to the length of the sample receiving element at which it encounters an obstacle for design reasons) and the rotatable element has simultaneously stopped at the end of the linear drive facing the first opening of the lock, the groove of the sample receiving element and the pin on the arm of the rotatable element are located in one plane and next to each other (i.e., the groove of the sample receiving element is in the receiving position for the pin of the arm of the rotatable element, so that in a next step, the pin can be inserted into the groove by moving the rotatable element).

The above-mentioned preferred embodiments of the invention each contribute to ensuring that, after the sample receiving element has been inserted into the first opening of the lock, the groove of the sample receiving element is ideally immediately in a position relative to the arm of the rotatable element which, when the rotatable element is rotated, enables the pin located on the arm of the rotatable element to be safely inserted into the groove. In this way, any operating errors by users can be minimized.

The obstacle of the lock (preferably located inside the lock) against which a sample receiving element abuts when inserted into the first opening is adapted to the movement of the sample receiving element exerted by the transport device in such a way that transport of the sample receiving element through the lock is not impeded by this. Preferably, the lock additionally comprises a mechanism by which the obstacle is deflected from the transport path of the sample receiving element when the transport device begins to move the sample receiving element to be inserted, so that the sample receiving element can move unimpeded through the lock into the internal area of the mass spectrometer. After the rotatable element stops at the end of the linear drive facing the first opening (for example, after “retracting” of the rotatable element due to the discharging of a sample receiving element), the obstacle preferably moves automatically back into the transport path of the sample receiving element in order to once again exert its blocking effect for another sample receiving element to be inserted into the lock.

The first opening of the lock is usually designed as an operator interface which (provided that the first opening is not closed by the first lock gate) is used to insert or remove a sample receiving element. Preferably, the cutout of the first opening is designed so that the sample receiving element to be inserted into the first opening can be inserted into the opening with a precise fit. The sample receiving element is preferably inserted into the first opening by hand.

A lock according to the invention is preferred, wherein the transport device is designed and configured to transfer a sample receiving element inserted into the first opening of the lock via the lock into a holder for sample receiving elements located in the internal area for ionization. The holder for sample receiving elements serves to fix the sample receiving element in place during the performance of a mass spectrometric analysis. Preferably, the holder for sample receiving elements is connected to a motion mechanism arranged in the internal area of the mass spectrometer so that the sample receiving element inserted into the holder can be moved during a mass spectrometric analysis or between several planned mass spectrometric analyses.

Preferably, the sample receiving element is fixed in the holder for sample receiving elements either partially or completely magnetically. For this purpose, both the sample receiving element and the holder for sample receiving elements preferably comprise magnets. The magnets of the sample receiving element and the magnets of the holder for sample receiving elements are arranged and aligned in such a way that when the sample receiving element is inserted or guided into or onto the holder, the magnets of the sample receiving element interact with the magnets of the holder, and thereby causing the sample receiving element to be fixed in or on the holder. The interaction can consist of either attraction or repulsion of the respective magnet pairs. When the sample receiving element is inserted into the holder, the magnets of the sample receiving element are preferably aligned and arranged with the magnets of the holder in such a way that, after the sample receiving element has been completely inserted into the holder, a repulsive force prevails between the respective magnet pairs of the two components (sample receiving element and holder) after the sample receiving element has been fully inserted into the holder, which force presses the sample receiving element against the holder. Preferably, the respective magnet pairs are arranged axially offset relative to each other for this purpose when the sample receiving element is fully inserted into the holder.

Magnetic fixation of the sample receiving element in the holder (at least as a supporting measure) has the advantage that it ensures a secure and firm hold of the sample receiving element with reproducible alignment, which can be reversed with comparatively little effort to remove the sample receiving element again.

Part of the invention is also a set, preferably a set for a mass spectrometer, comprising a holder for sample receiving elements and a sample receiving element that can be held by the holder, wherein the holder and the sample receiving element comprise at least one pair of magnets for fixing the sample receiving element in or on the holder, and one of the magnets of the pair is arranged in or on the holder and the second magnet of the pair is arranged in or on the sample receiving element. A set according to the invention is preferred, wherein the at least one pair of magnets for fixing the sample receiving element is aligned and arranged in such a way that, after the sample receiving element has been fully inserted into or attached to the holder, there is an underlying repulsive force between the two magnets of the pair, which presses the sample receiving element against the holder. A set according to the invention is also preferred, wherein the at least one pair of magnets is arranged axially offset relative to each other when the sample receiving element is fully inserted into the holder and/or when the sample receiving element and the holder are in the intended connected state. Preferably, the set according to the invention comprises more than one pair of magnets for fixing the sample receiving element, more preferably 2 to 6 pairs of magnets. With regard to the advantages of such magnetic fixing of a sample receiving element in or on the holder and further details thereof, reference is made to the corresponding explanations above in the text. Part of the invention is also a mass spectrometer comprising a set according to the invention (as defined above and in the claims).

Preferably, sample carriers are also fixed magnetically in or on sample receiving elements (at least as a supporting measure). More preferably by one or more pairs of magnets which exert a mutual attractive force on each other. The pairs of magnets can, for example, be arranged in or on the sample carriers and the sample receiving elements, so that the attractive magnetic effect occurs when the sample carriers and sample receiving elements are brought together in the desired alignment.

Alternatively, the sample receiving element can also be designed in two parts, for example, with a first part for inserting sample carriers and a second part for clamping the sample carrier in the sample receiving element. In such cases, the respective pairs of attracting magnets are preferably located in or on the first and second part of the sample receiving element, so that when the two parts are brought together, the clamping effect that holds the sample carrier is achieved by magnetic attraction between the first and second part of the sample receiving element. In addition or alternatively, the fixation of sample carriers in or on sample receiving elements can preferably also be effected by one or more, preferably spring-loaded, pressure pins, by means of which the sample carriers are pressed against the sample receiving elements and are thus fixed to them. The advantages of such fixation are that it is reversible and easy to release, and yet still allows a sample carrier to be held sufficiently firmly inside a sample receiving element in an easily reproducible orientation.

A lock according to the invention is also preferred, wherein the transport device is designed and configured to first transport a sample receiving element inserted into the first opening of the lock completely into the lock, so that, before the second lock gate is opened and the sample receiving element is transported further into the internal area of the mass spectrometer, the first and second openings of the lock can be closed by the first and second lock gates and a negative pressure can be generated in the lock (i.e., the lock can be evacuated). In other words, the lock is preferably designed to completely accommodate the sample receiving element to be transported in its interior. The transport device is in turn preferably designed to first transport a sample receiving element to be transported completely into the internal area of the lock, to stop there, and to continue transport toward the internal area of the mass spectrometer at a later point in time, for example after the lock has been evacuated.

A lock according to the invention is preferred, wherein the transport device or the rotatable element additionally comprises one or more means by which a rotational movement of the rotatable element is prevented over at least a partial distance of the path that can be covered by the rotatable element between the first and second openings of the lock. Such partial blocking of the rotational movement can be advantageous, for example, in order to maintain contact between the groove of the sample receiving element to be transported and the pin on the arm of the rotatable element, once this contact has been generated by performing a rotational movement, for as long as necessary and not to lose it again accidentally due to further rotation during the execution of a linear movement by the linear drive of the transport device. Such blocking can also be useful to prevent further rotation after the desired complete rotation of the rotatable element, for example by 180°.

The one or more means by which a rotational movement of the rotatable element is prevented over at least a partial distance of the path that can be covered by the rotatable element between the first and second openings of the lock preferably comprise magnetic elements and/or a groove and a pin that can be inserted into it and/or a torsion spring.

A lock according to the invention is preferred, wherein the first and/or second lock gate comprises a toggle lever drive. Such a toggle lever drive is particularly suitable for performing the above-described movement of a preferred lock gate toward the first and/or second opening of the lock, whereby the opening can be completely covered and closed by the lock gate. At the same time, the use of a toggle lever drive allows such movement to be achieved while requiring little space for the first and/or second lock gate and its movement mechanism.

The presence of a toggle lever drive also enables effective implementation of the preferred self-closing or self-locking effect of the lock gate. In the case of the existence of a toggle lever drive, a self-closing effect can be achieved by the toggle lever being pressed over by the closing element of the lock gate onto the opening to be closed when it is moved towards it, which blocks the movement of the toggle lever after the opening has been closed and significantly reduces the risk of accidental or inadvertent movement of the toggle lever back to the released position.

Part of the invention is also a mass spectrometer, in particular a MALDI-TOF mass spectrometer, comprising a lock according to the invention (as defined above and in the claims). Part of the invention is also a mass spectrometer, in particular a MALDI-TOF mass spectrometer, comprising
an internal area for ionizing a sample to be analyzed, wherein the internal area for ionization contains a holder for sample receiving elements that can be moved by means of piezoelectric motors (piezo stage), and
a lock, preferably a lock according to the invention (as defined above and in the claims),
wherein the insertion and removal of a sample receiving element from an external area of the mass spectrometer into the holder for sample receiving elements located in the internal area for ionization is carried out via the lock.

As explained above, such a mass spectrometer combines the ability to move a sample with high precision during mass spectrometric analysis with the simultaneous ability to maintain the atmosphere required for mass spectrometric analysis in the internal area of the mass spectrometer while samples are being exchanged by introducing and removing samples via a lock.

In the following, the invention is explained in more detail with reference to embodiments and the accompanying figures. The embodiments given below are intended to describe and explain the invention in more detail without limiting its scope.

The elements in the attached figures are not necessarily shown to scale, but are primarily intended to illustrate principles of the invention (largely schematically). In the figures, elements corresponding to one another in the different views are identified by the same reference signs.

### BRIEF DESCRIPTION OF THE DRAWINGS

FIG. 1A depicts a lock according to the invention.

FIG. 1B is a side view of the lock shown in FIG. 1A, looking at the first opening of the lock.

FIG. 1C is a side view of the lock shown in FIG. 1A, looking at the second opening of the lock.

FIG. 2A is an Illustration of a transport device of a lock according to the invention, wherein the rotatable element is in the starting position for receiving a sample receiving element (i.e., at the stop of the end of the linear drive facing the first opening).

FIG. 2B is a further illustration of the transport device shown in FIG. 2A after rotation of the rotatable element by 90°.

FIG. 2C is a further illustration of the transport device shown in FIG. 2A after the rotatable element has reached the stop at the end of the linear drive facing the second opening.

FIG. 2D is a further illustration of the transport device shown in FIG. 2A, including a sample receiving element inserted into the lock after the pin on the arm of the rotatable element has made contact with the groove in the sample receiving element.

FIG. 2E is a side view of the transport device shown in FIG. 2D, looking at the end of the linear drive facing the second opening.

FIG. 2F is a cross-section of a section of the rotatable element visible in FIG. 2A.

FIG. 3A is an illustration of a lock gate of a lock according to the invention (side view).

FIG. 3B is a 90° rotated illustration of the lock gate shown in FIG. 3A.

FIG. 3C is a perspective illustration of the lock gate shown in FIG. 3A.

FIG. 3D is a 180° rotated illustration of the lock gate shown in FIG. 3C.

### DETAILED DESCRIPTION

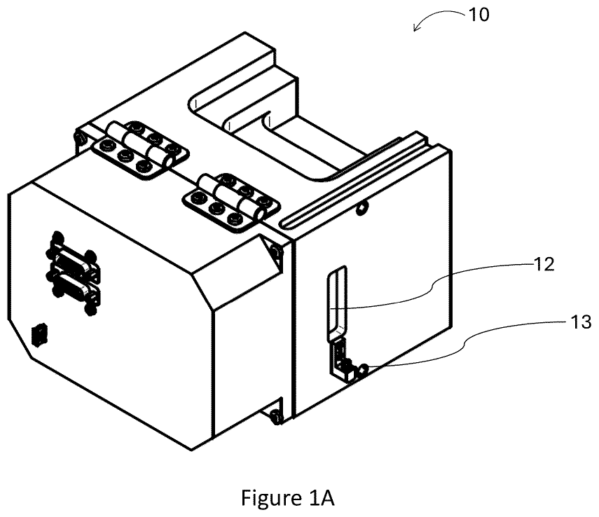

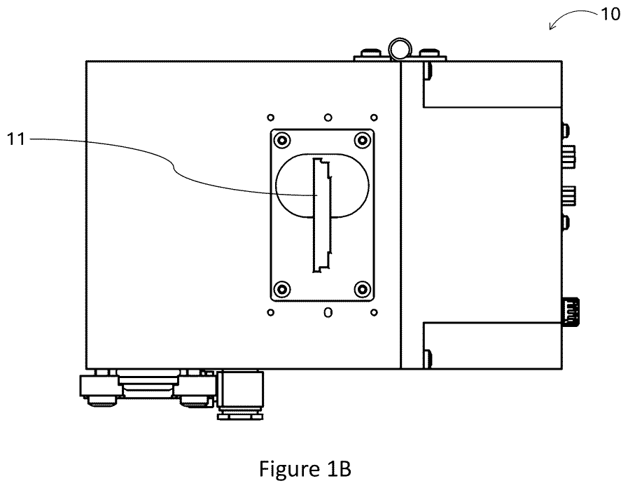

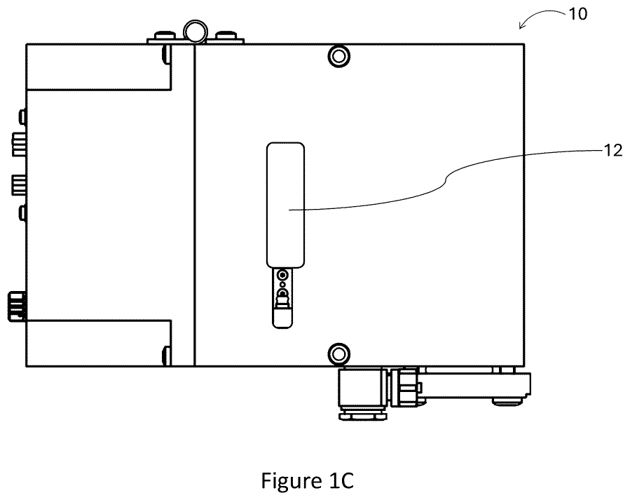

FIG. 1A shows an example of a lock 10 according to the invention, comprising a first opening 11 for inserting a sample receiving element 16 from an external area into the lock 10 (see FIG. 1B, not visible in FIG. 1A) and comprising a second opening 12 for inserting a sample receiving element 16 from the lock 10 into an internal area of the mass spectrometer.

The embodiment of a lock 10 according to the invention shown in FIG. 1A also comprises a catch bolt 13 on its outer wall below the second opening 12 for a motion mechanism located in the internal area of the mass spectrometer or a holder for sample receiving elements 16 attached to the motion mechanism. Usually, a sample receiving element 16 inserted through the second opening 12 into the internal area of the mass spectrometer is placed directly on or attached to a motion mechanism located in the internal area of the mass spectrometer, and the sample receiving element 16 is typically inserted into a holder for the sample receiving elements 16 attached to the motion mechanism. In this context, the catch bolt 13 serves to minimize the force acting on the motion mechanism during the transfer of the sample receiving element 16 by absorbing at least part of this force, thus enabling a controlled and as gentle as possible transfer of the sample receiving element 16 onto or on the often very sensitive motion mechanism. The second opening 12 and the catch bolt 13 can be viewed again from a different perspective in the side view of the lock 10 shown in FIG. 1C.

FIG. 1B shows a side view of the lock 10 shown in FIG. 1A, in which the first opening 11 of the lock 10 is clearly visible. In the embodiment shown, the shape of the first opening 11 is matched to the shape of the sample receiving elements 16 to be inserted into the lock 10 in such a way that sample receiving elements 16 can only be inserted into the lock 10 through the first opening 11 in a specific orientation. This ensures that sample receiving elements 16 are always inserted into the lock 10 with the correct orientation, so that, for example, the pin 1412 on the arm 1411 of the rotatable element 141 can be inserted directly into the groove 161 of the sample receiving element 16 to be transported after the sample receiving element 16 has been inserted into the lock 10. Specifying the correct alignment of the sample receiving element 16 for insertion into the first opening 11 of the lock 10 by means of a special shape of the first opening 11 is particularly helpful because the insertion of sample receiving elements 16 into the lock 10 is usually done manually and a specific specification of the alignment for the insertion of sample receiving elements 16 into the lock 10 can prevent potential operator errors.

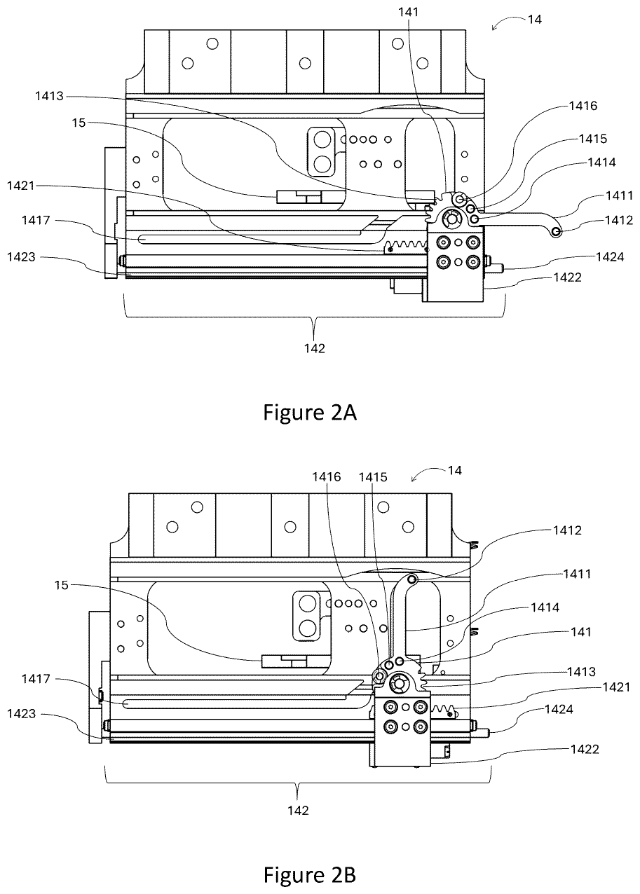

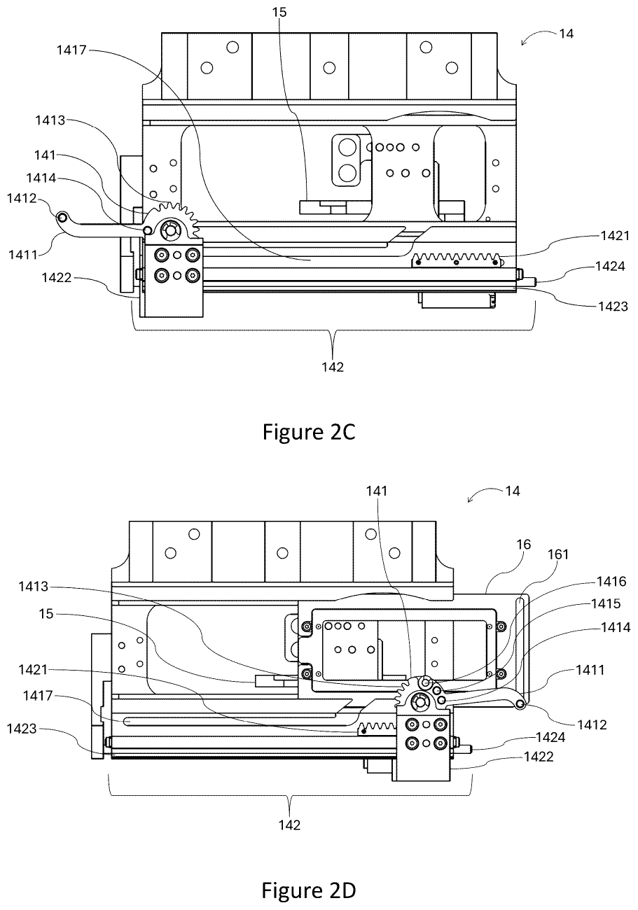

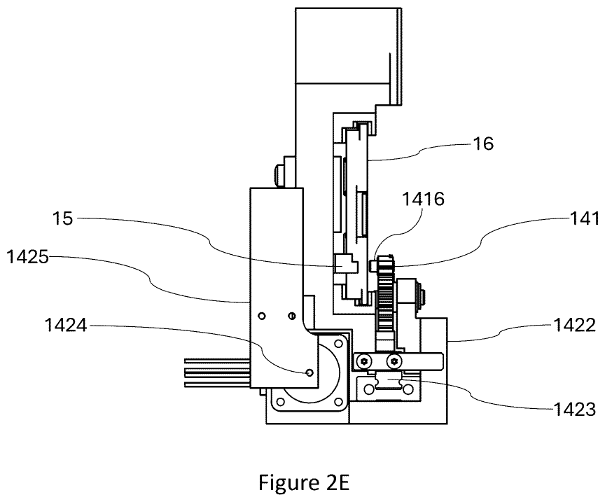

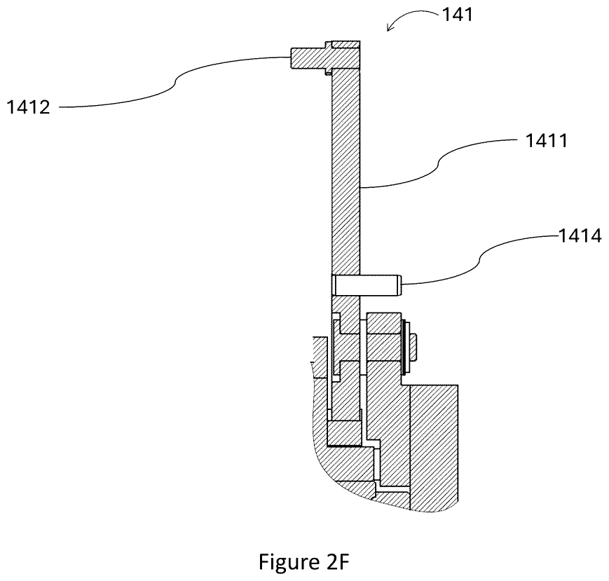

FIG. 2A shows the transport device 14 located in the lock 10. The rotatable element 141 of the transport device 14 is located in the illustration according to FIG. 2A at the end of the linear drive 142 facing the first opening 11 and, thus, in the “start position” for receiving a sample receiving element 16 that can be pushed into the lock 10 by the operator. The arm 1411 of the rotatable element 141 has a straight main section and a bend at its end. In the start position shown in FIG. 2A, the arm 1411 faces the first opening 11 and the main section of the arm 1411 is aligned horizontally. The bent end of the arm 1411 points downward in this position. In the starting position, the gear-like section 1413 of the rotatable element 141 is also located above a rack 1421, which is also arranged at the end of the linear drive 142 facing the first opening 11. At the same time, the rotatable element 141 is connected via a motor flange/connecting piece 1422 to a motor 1425 (not visible in FIG. 2A), which is located on the opposite side of the transport device 14. The motor 1425 itself is mounted on a threaded rod 1424, on which the motor 1425 can move between the two ends of the linear drive 142. Due to the connection of the motor 1425 to the rotatable element 141, a linear movement of the motor 1425 also causes a linear movement of the rotatable element 141. The linear movement of the rotatable element 141 is additionally stabilized by a guide element 1423, along which the rotatable element moves.

FIG. 2B shows the transport device 14 of FIG. 2A after a movement of the rotatable element 141 towards the second opening 12 of the lock 10. During a movement of the rotatable element 141 from the end of the linear drive 142 facing the first opening 11 towards the second opening 12 of the lock 10, a rotational movement of the rotatable element 141 and its arm 1411 is also caused due to the meshing of the gear-like section 1413 and the rack 1421. This rotational movement serves to insert the pin 1412 on the arm 1411 of the rotatable element 141 into the groove 161 of a sample receiving element 16 that can be inserted into the lock 10 on the operator side and thereby to bring the transport device 14 or its rotatable element 141 into contact with the sample receiving element 16 to be transported, so that the movement of the rotatable element 141 can also cause a movement of the sample receiving element from the first opening 11 in the direction of the second opening 12 of the lock 10. As a sample receiving element 16 to be transported is contacted with the rotatable element 141 via the pin 1412 located on the arm 1411, the sample receiving element 16 to be transported undergoes a movement directed towards the second opening 12 of the lock 10 due to both the linear movement of the rotatable element 141 initiated by the motor 1425 (not visible in FIG. 2B) and the rotational movement of the arm 1411 or pin 1412 of the rotatable element 141 initiated by the meshing of the rack 1421 and the gear-like section 1413. As a result, the transport device 14, despite its arrangement inside the lock 10, achieves a transport path for the sample receiving element 16 which exceeds the length of the lock 10 and enables not only transport of the sample receiving element 16 inside the lock 10 by the transport device 14, but also further transport into the internal area of the mass spectrometer. The rotational movement of the rotatable element 141 does not itself cause the sample receiving element 16 to be transported to undergo a rotational movement, since the groove 161 of the sample receiving element 16 is at least as long as the longest vertical extension of the pin 1412 that can run in the groove 161 and thus “merely” a movement of the pin 1412 in the direction of one of the two openings of the lock 10 is transmitted to the sample receiving element 16. This leads to a simpler, space-saving and more controllable movement of a sample receiving element 16 to be transported through the lock.

The rotatable element 141 shown in FIG. 2B can perform a total rotational movement of 180°. Accordingly, both the gear-like section 1413 of the rotatable element 141 and the rack 1421 are precisely designed to perform a rotation of 180°. In the embodiment shown, further rotation of the rotatable element 141 is also prevented by a stop 1414 arranged on the rotatable element 141 to limit the rotational movement of the rotatable element 141.

Rotation of the rotatable element 141 should generally only take place in the area comprising the rack 1421. According to the embodiment shown, a rotation prevention prevents the rotatable element 141 from rotating back in areas of the transport path without a rack 1421. The rotation prevention consists of a pin 1416 for the rotation prevention arranged on the rotatable element 141, which enters a groove 1417 after the rotatable element 141 has rotated through 180°. The groove 1417 of the rotation prevention adjoins the area of the transport path with rack 1421 and extends in the direction of the second opening 12 of the lock 10. By running the pin 1416 of the rotation prevention in the groove 1417 of the rotation prevention in those areas of the transport path without a rack 1421, a back rotation of the rotatable element 141 after the original rotation of 180° has been completed is prevented on the further path of the rotatable element 141 towards the second opening 12 of the lock 10.

In order to ensure that the pin 1416 of the rotation prevention runs as smoothly as possible in the groove 1417 of the rotation prevention, the pin 1416 of the rotation prevention is held in its path through the groove 1417 of the rotation prevention by the action of magnetic forces preferably in the center of the groove 1417 and thus with as little contact as possible with it. To achieve such a magnetic effect, the rotatable element 141 shown additionally comprises a magnet 1415, which interacts with a second magnet located in the motor flange/connecting piece 1422 (not visible in the illustrations) and thereby holds the rotatable element in a position in which the pin 1416 of the rotation prevention is held with as little contact as possible with the inner sides of the groove 1417.

The bend at the end of the arm 1411 of the rotatable element 141 causes the pin 1412 located on the arm 1411 to remain within the groove 161 of the sample receiving element 16 even after the arm 1411 has rotated by 180° thus ensuring that contact between the rotatable element 141 and the sample receiving element 16 is maintained even after the arm 1411 has completed its rotation, allowing the sample receiving element 16 to continue moving toward the second opening 12 of the lock 10. This contact between the rotatable element 141 and the sample receiving element 16 can usually be easily released after the sample receiving element 16 has been completely transported into the internal area of the mass spectrometer, for example by means of a slight upward movement of a motion mechanism on or to which the sample receiving element has been placed in the internal area of the mass spectrometer.

FIG. 2C shows the transport device 14 of FIG. 2A after the stop of the rotatable element 141 at the end of the linear drive 142 facing the second opening 12 and thus after a complete movement through the lock 10. In this position, the main section of the arm 1411 of the rotatable element 141 is again in a horizontal orientation. In addition, in this position, the arm 1411 of the rotatable element 141 protrudes through the second opening 12 of the lock 10 into the internal area of the mass spectrometer in order to ensure complete transport of a sample receiving element 16 into the internal area of the mass spectrometer.

FIG. 2D shows a sample receiving element 16 in addition to the transport device 14. FIG. 2D illustrates the process of inserting the pin 1412 located on the arm 1411 of the rotatable element 141 into the groove 161 of a sample receiving element 16 inserted into the lock 10 by rotating the rotatable element 141.

In order to easily insert the pin 1412 located on the arm 1411 of the rotatable element 141 into the groove 161 of a sample receiving element 16 inserted into the lock 10, in addition to the correct alignment of the sample receiving element 16 with which it is inserted into the lock 10, it is also important that the sample receiving element 16 is inserted into the lock 10 far enough so that the opening of the groove 161 of the sample receiving element 16 and the pin 1412 located on the arm 1411 of the rotatable element 141 are ideally directly opposite each other. In order to ensure such positioning of the opening of the groove 161 of the sample receiving element 16 and the pin 1412 located on the arm 1411 of the rotatable element 141 in a reproducible manner, the transport device 14 shown in the figures comprises an obstacle 15 against which a sample receiving element 16 abuts when inserted into the first opening 11 and which limits the length to which a sample receiving element 16 can be inserted into the lock 10. The obstacle 15 is mechanically coupled to the linear drive 142 in such a way that when the rotatable element 141 moves out of the starting position, the obstacle 15 is simultaneously moved, thereby moving the obstacle 15 out of the transport path for the sample receiving element 16 and allowing the sample receiving element 16 to be transported further into the interior of the lock 10. Conversely, when the rotatable element 141 stops at the end of the linear drive 142 facing the first opening 11, i.e., by the arrival of the rotatable element 141 at its starting position for the transport of a sample receiving element 16 into the internal area of the mass spectrometer, a movement of the obstacle 15 into the transport path for sample receiving elements 16 is triggered.

FIG. 2E shows the illustration shown in FIG. 2D rotated by 90°. The view clearly shows the arrangement of the motor 1425, which is located on a threaded rod 1424. Furthermore, the shapes of the guide element 1423 for the rotatable element 141 and the obstacle 15 are clearly visible. In this view, the obstacle 15 is still partially located in the transport path for the sample receiving element 16.

FIG. 2F shows in cross-section a section of the rotatable element 141, in which the shape and position of the pin 1412 located on the arm 1411 of the rotatable element 141 are illustrated more clearly. FIG. 2F also shows the stop 1414 for limiting the rotational movement of the rotatable element 141. The pin of the rotation prevention 1416, which is also located on the rotatable element 141 shown in the figures, is not visible in the section shown in FIG. 2F. It would protrude out of the left-hand area, which is cut off in FIG. 2F.

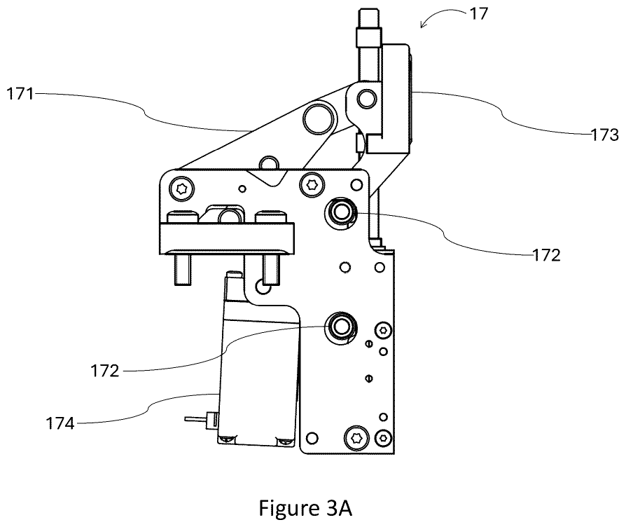

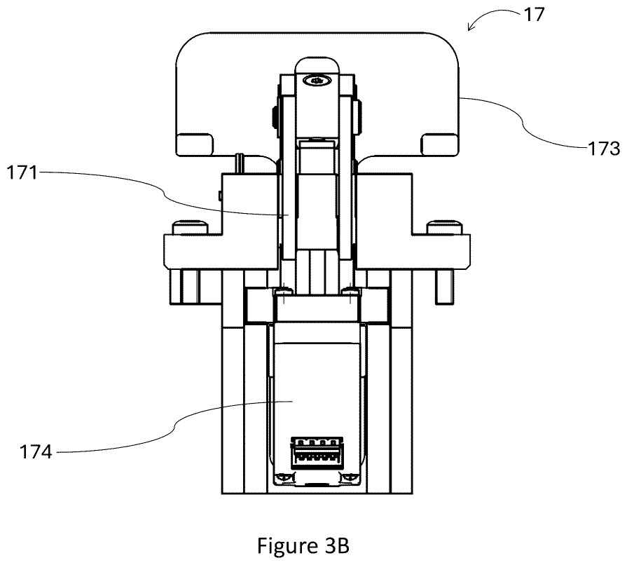

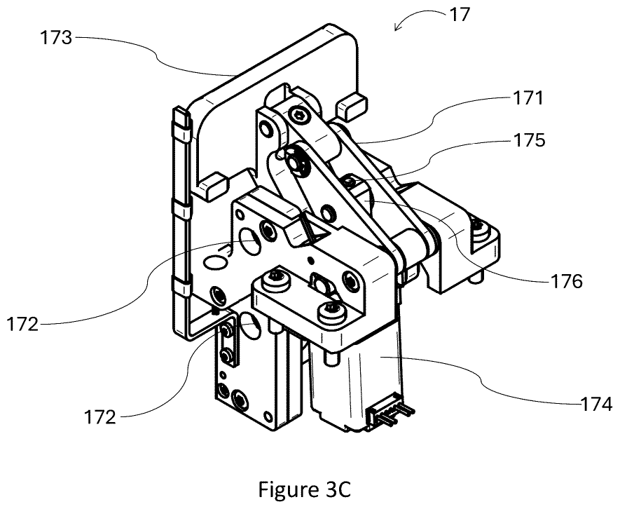

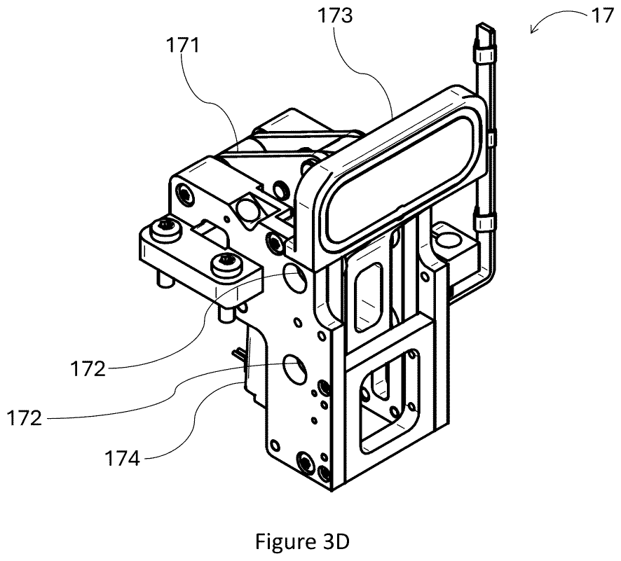

FIG. 3A shows a side view of a lock gate 17 located in lock 10. FIG. 3B shows the same view rotated by 90°. FIGS. 3C and 3D show perspective views of the same lock gate 17 from different angles. The figures clearly show the toggle lever 171, which can be used to press the closing element 173 against one of the openings of the lock 10 in order to close it. The closing element 173 has a seal which ensures that the openings are closed airtight when the closing element is pressed against one of the openings. The toggle lever 171 is moved by a spindle nut 176, which is connected to the toggle lever 171. The spindle nut 176 is located on a spindle 175, which can be rotated by a motor 174. Rotation of the spindle 175 allows the spindle nut 176 located on it to be moved along the spindle 175, which, due to the connection between the spindle nut 176 and the toggle lever 171, also causes the toggle lever 171 to move at the same time.

The toggle lever 171 also has a connection to a guide element, which causes a controlled movement of the toggle lever 171. The guide element comprises two guide rails and a guide rod equipped with guide rollers 172 on both sides, wherein the guide rollers 172 are movably arranged inside the guide rails and the guide rod is coupled to the toggle lever 171. The guide element ensures that the toggle lever 171 and the closing element 173 located thereon for closing an opening of the lock 17 initially move parallel to the wall of the lock 10 comprising the opening to be closed. The movement parallel to the wall comprising the opening takes place without the closing element 173 coming into contact with the wall in order to avoid friction between the seal of the closing element 173 and the wall and any associated damage to the seal.

Only after reaching the level of the opening to be closed the guide element allows, by means of notches in its guide rails, movement of the toggle lever 171 and the closing element 173 located thereon in the direction of the wall comprising the opening and pressing the closing element 173 against that position of the wall at which the opening is located. The movement mechanism that can be executed by the lock gate 17 allows the openings of the lock 10 to be opened and closed easily and safely with comparatively little space required.

### LIST OF REFERENCE SIGNS

10 Lock
11 first opening for inserting a sample receiving element from an external area into the lock
12 second opening for inserting a sample receiving element from the lock into an internal area of the mass spectrometer
13 catch bolt for a motion mechanism located in the internal area of the mass spectrometer or a holder for sample receiving elements attached to the motion mechanism
14 transport device
15 obstacle which a sample receiving element abuts when inserted into the first opening
16 sample receiving element
17 lock gate
141 rotatable element
142 linear drive
161 groove of the sample receiving element
171 toggle lever
172 guide rollers of the guide element of the toggle lever drive
173 closing element
174 motor for toggle lever drive
175 spindle for toggle lever drive
176 spindle nut for toggle lever drive
1411 arm of the rotatable element
1412 pin located on the arm
1413 gear-like section of the rotatable element
1414 stop for limiting the rotational movement of the rotatable element
1415 magnet of the rotation prevention
1416 pin of the rotation prevention
1417 groove for rotation prevention
1421 rack
1422 motor flange (connecting piece for connecting the motor and the rotatable element)
1423 guide element for transport device
1424 threaded rod
1425 motor for transport device

1. A lock for introducing and discharging a sample receiving element into a mass spectrometer, comprising:
a first opening for introducing the sample receiving element from an external area into the lock;
a second opening for introducing the sample receiving element from the lock into an internal area of the mass spectrometer;
a first lock gate for closing the first opening of the lock; and
a second lock gate for closing the second opening of the lock,
wherein the lock additionally comprises a transport device arranged in the lock for transporting the sample receiving element from the first opening of the lock into the internal area of the mass spectrometer, wherein the transport device comprises the following components:
a rotatable element comprising
an arm,
a pin located on the arm, which can be inserted into a groove of the sample receiving element to be transported, and
a gear-like section, and
a linear drive for moving the rotatable element from the first opening of the lock into the internal area of the mass spectrometer, wherein the linear drive comprises a rack on at least one section and the rack is designed to engage with the teeth of the gear-like section of the rotatable element,
wherein the rotatable element performs a rotational movement when passing over the rack, so that the pin located on the arm of the rotatable element can be guided into and along the groove located in the sample receiving element and, upon contact of the pin with the sample receiving element, a movement of the sample receiving element from the first opening of the lock into the internal area of the mass spectrometer can be achieved by movement of the pin.

2. The lock according to claim 1, wherein
the first opening of the lock can be closed airtight by the first lock gate and/or
the second opening of the lock can be closed airtight by the second lock gate and/or
a negative pressure can be generated in the lock when the first and second openings are closed.

3. The lock according to claim 1, wherein the linear drive comprises a threaded rod.

4. The lock according to claim 1, wherein the linear drive has a section comprising a rack at at least one of its two ends.

5. The lock according to claim 1, wherein all sections of the linear drive which comprise a rack together cause a rotational movement of the rotatable element by 180°.

6. The lock according to claim 1, wherein the arm of the rotatable element is aligned horizontally when the rotatable element stops at the end of the linear drive facing the first opening.

7. The lock according to claim 6, wherein the arm of the rotatable element is aligned horizontally when the rotatable element stops at any one of the two ends of the linear drive.

8. The lock according to claim 1, wherein the arm of the rotatable element has a bend at its end.

9. The lock according to claim 8, wherein the bend of the arm points downward when the rotatable element stops at the end of the linear drive facing the first opening of the lock.

10. The lock according to claim 1, wherein the lock additionally comprises an obstacle against which a sample receiving element abuts when inserted into the first opening and by which the length to which a sample receiving element can be inserted through the first opening into the lock is limited.

11. The lock according to claim 1, wherein the shape of the sample receiving element is matched to the shape of the first opening of the lock in such a way that the sample receiving element can only be inserted into the first opening in one orientation.

12. The lock according to claim 1, wherein the arrangement and design of the first opening of the lock, the transport device of the lock and the sample receiving element that can be inserted into the first opening of the lock are matched to each other in such a way that that after the sample receiving element has been inserted into the first opening and the rotatable element has simultaneously stopped at the end of the linear drive facing the first opening of the lock, the groove of the sample receiving element and the pin on the arm of the rotatable element are located in one plane and next to each other.

13. The lock according to claim 1, wherein the transport device additionally comprises one or more means by which a rotational movement of the rotatable element is prevented over at least a partial distance of the path that can be covered by the rotatable element between the first and second openings of the lock.

14. A mass spectrometer comprising a lock as defined in claim 1.

15. A lock for introducing and discharging a sample receiving element into a mass spectrometer, comprising:
a first opening for introducing the sample receiving element from an external area into the lock;
a second opening for introducing the sample receiving element from the lock into an internal area of the mass spectrometer;
a first lock gate for closing the first opening of the lock; and
a second lock gate for closing the second opening of the lock,
wherein the first and/or second lock gate
is arranged inside the lock, and
is designed and configured to first move parallel to that wall in which the opening to be closed is located and, after reaching the level of the opening, to move toward the opening so that the opening is completely covered and closed by the lock gate.

16. The lock according to claim 15, wherein the first and/or second lock gate comprises a toggle lever drive.

17. A mass spectrometer comprising a lock as defined in claim 15.

18. A set of components for introducing a sample to be measured to a mass spectrometer, the set comprising:
a sample receiving element; and
a holder for holding the sample receiving element, wherein the holder and the sample receiving element comprise at least one pair of magnets for fixing the sample receiving element in or on the holder, with a first magnet of the pair being arranged in or on the holder and a second magnet of the pair being arranged in or on the sample receiving element.

19. The set according to claim 18, wherein the at least one pair of magnets for fixing the sample receiving element in or on the holder is aligned and arranged in such a way that, after the sample receiving element has been fully inserted into or attached to the holder, there is an underlying repulsive force between the two magnets of the pair, which presses the sample receiving element against the holder.

20. The set according to claim 18, wherein the magnets of the at least one pair of magnets are arranged axially offset relative to each other when the sample receiving element is fully inserted into the holder and/or when the sample receiving element and the holder are in an intended connected state.

21. A mass spectrometer comprising a set as defined in claim 18.

22. A mass spectrometer comprising:
an internal area for ionizing a sample to be analyzed, wherein the internal area for ionization contains a holder for sample receiving elements that can be moved by means of piezoelectric motors; and
a lock,
wherein insertion and removal of a sample receiving element from an external area of the mass spectrometer into the holder for sample receiving elements located in the internal area for ionization is carried out via the lock.
